(19) United States
(12) Patent Application Publication
(10) Pub. No.: US 2021/0390267 A1
(43) Pub. Date: Dec. 16, 2021

(54) SMART ITEM TITLE REWRITER

(71) Applicant: eBay Inc., San Jose, CA (US)

(72) Inventors: Maoquan Wang, Shanghai (CN); Yuyangzi Fu, Nantong (CN); Jingying Wang, Shanghai (CN)

(21) Appl. No.: 16/900,712

(22) Filed: Jun. 12, 2020

(51) Int. Cl. G06F 40/56; G06N 20/00; G06Q 30/06

(52) U.S. Cl. CPC G06F 40/56; G06Q 30/0627; G06Q 30/0641; G06N 20/00

(57) ABSTRACT

Methods for determining a refined title to present in a search results page for a product are described. Components of a server system may receive a set of input titles for a set of listings associated with a product. Components of the server system may receive a listing request including a suggested title for a first listing for the product. The components of the server system may generate a refined title for the first listing based on the set of input titles and the suggested title. The components of the server system may then receive, from a user device, a search query that may be mapped to the product, and the component of the server system may transmit, to the user device, a query response that includes the refined title for the first listing based on the search query.

### FIELD OF TECHNOLOGY

The present disclosure relates generally to server systems and data processing, and more specifically to a smart item title rewriter.

### BACKGROUND

Computer networks permit the transport of data between interconnected computers. Search engine technology permits a user to obtain information from a vast array of sources available via a computer network. A search engine may be a program that searches for and identifies content in a database that correspond to keywords or characters input by the user, and may return websites available via the Internet based on the search. To generate a search, a user may interact with a user device, such as a computer or mobile phone, to submit a search query via a search engine. The search engine may execute the search and display results for the search query based on communication with other applications and servers. In some cases, mobile devices may offer limited screen sizes. Specifically, as screen sizes for presentation of information are becoming smaller while data is growing exponentially, accurate text summarization is becoming relevant for search engines, e-Commerce websites, news websites, social-networking websites, and so forth. Techniques for efficiently summarizing text to be displayed on a screen are therefore desired.

### SUMMARY

A method of generating a refined title of a listing for a product is described. The method may include receiving a set of input titles for a set of listings associated with a product, receiving a listing request including a suggested title for a first listing for the product, generating a refined title for the first listing based on the set of input titles and the suggested title, receiving a query that is mapped to the product, and transmitting a query response that includes the refined title for the first listing based on the search query.

An apparatus for generating a refined title of a listing for a product is described. The apparatus may include a processor, memory coupled with the processor, and instructions stored in the memory. The instructions may be executable by the processor to cause the apparatus to receive a set of input titles for a set of listings associated with a product, receive a listing request including a suggested title for a first listing for the product, generate a refined title for the first listing based on the set of input titles and the suggested title, receive a query that is mapped to the product, and transmit a query response that includes the refined title for the first listing based on the search query.

Another apparatus for generating a refined title of a listing for a product is described. The apparatus may include means for receiving a set of input titles for a set of listings associated with a product, receiving a listing request including a suggested title for a first listing for the product, generating a refined title for the first listing based on the set of input titles and the suggested title, receiving a query that is mapped to the product, and transmitting a query response that includes the refined title for the first listing based on the search query.

A non-transitory computer-readable medium storing code for generating a refined title of a listing for a product is described. The code may include instructions executable by a processor to receive a set of input titles for a set of listings associated with a product, receive a listing request including a suggested title for a first listing for the product, generate a refined title for the first listing based on the set of input titles and the suggested title, receive a query that is mapped to the product, and transmit a query response that includes the refined title for the first listing based on the search query.

Some examples of the method, apparatuses, and non-transitory computer-readable medium described herein may further include operations, features, means, or instructions for training a machine learning model based on user behavior data corresponding to the set of listings, where the refined title may be generated based on the machine learning model.

In some examples of the method, apparatuses, and non-transitory computer-readable medium described herein, training the machine learning model further may include operations, features, means, or instructions for receiving the user behavior data including click rate data, sales rate data, or both, and training the machine learning model based on the received user behavior data.

In some examples of the method, apparatuses, and non-transitory computer-readable medium described herein, generating the refined title may include operations, features, means, or instructions for identifying a set of words in the listing request including the suggested title, and adding a word from the set of words to the refined title based on the machine learning model.

In some examples of the method, apparatuses, and non-transitory computer-readable medium described herein, generating the refined title may include operations, features, means, or instructions for identifying a set of words in the listing request including the suggested title, and excluding, from the refined title, a word from the set of words based on the machine learning model.

In some examples of the method, apparatuses, and non-transitory computer-readable medium described herein, generating the refined title may include operations, features, means, or instructions for selecting a relative order between two or more words in the refined title based on the machine learning model.

In some examples of the method, apparatuses, and non-transitory computer-readable medium described herein, generating the refined title may include operations, features, means, or instructions for substituting a first word from the suggested title for a second word in the refined title based on the machine learning model.

### BRIEF DESCRIPTION OF THE DRAWINGS

FIG. 1 illustrates an example of a server system that supports smart item title rewriter in accordance with aspects of the present disclosure.

FIG. 2 illustrates an example of an application flow that supports smart item title rewriter in accordance with aspects of the present disclosure.

FIG. 3 illustrates an example of a system that supports smart item title rewriter in accordance with aspects of the present disclosure.

FIG. 4 illustrates an example of a webpage that supports smart item title rewriter in accordance with aspects of the present disclosure.

FIG. 5 illustrates an example of a process flow that supports smart item title rewriter in accordance with aspects of the present disclosure.

FIG. 6 shows a block diagram of an apparatus that supports smart item title rewriter in accordance with aspects of the present disclosure.

FIG. 7 shows a block diagram of a title generation component that supports smart item title rewriter in accordance with aspects of the present disclosure.

FIG. 8 shows a diagram of a system including a device that supports smart item title rewriter in accordance with aspects of the present disclosure.

FIGS. 9 through 12 show flowcharts illustrating methods that support smart item title rewriter in accordance with aspects of the present disclosure.

### DETAILED DESCRIPTION

A platform of an online marketplace often permits sellers to provide a description of an item being listed for sale. An item may refer to a product with a particular set of unique properties. For example, an item may be an iPad having a particular amount of storage (e.g., 16 GB, 32 GB), in a particular color (e.g., black, silver), and in a particular condition (e.g., new, used). When a prospective buyer initiates a product search, the platform (e.g., a search platform) of the online marketplace identifies a set of item listings that match the product search, and transfers the listings of the items available for sale for presentation to the prospective buyer. A browser may present to the prospective buyer a search results page that includes thumbnail-sized listings matching the search, and the buyer may select one or more of the listings to display a larger version of the selected thumbnail. With expanding platforms, online purchases are being executed on mobile phones instead of laptops and desktops. It is challenging to present a long description for a product listing on a mobile screen. Specifically, a screen size of a mobile phone is less than a screen size of a computer (e.g., laptop, desktop), and long titles in a listing may not be displayed fully on a mobile screen.

The techniques described herein may provide for generating a refined title for a product. In an example, a server system may host an online application, such as website or a software application (“App”). In some cases, the online application that may be accessible by end user client computing devices (e.g., laptops or mobile devices) via a computer network. In an example, the online application may be a customer facing website for an online marketplace (e.g., an online retail platform) where a user may purchase goods and/or services via the online application. In some cases, the online marketplace may permit a seller (e.g., a business or user) to set a price for an item being sold. An item may refer to a product having a particular set of characteristics. In some examples, the online marketplace may implement an online auction where sellers may submit bids at a desired price for an item.

The online application may provide a graphical user interface that may be presented at a user device in which a seller may generate a listing of one or more items (e.g., products, services, etc.) that the seller would like to sell. As part of generating the listing, the online application may, in some examples, prompt the seller to upload images (e.g., photos) of the item for sale, input a description of the item, a title for the listing, a universal product code (UPC) for the item, provide a sale price or a starting bid price for an online auction, include a purchase it now price for the item, or any combination thereof. A seller may utilize the online application to list for sale multiple items of the same type, or a variety of items of different types of items (e.g., different types of products). Multiple sellers may also upload listings for the same item, or for similar items with slight differences (e.g., size, color, generation, etc.).

A buyer may utilize their user device (e.g., a buyer device) to access the online application and to browse different listings of items available for sale from one or more sellers. The buyer may input, via a user device (e.g., a mobile device) presenting a graphical user interface provided by the online application, a search query describing an item (e.g., product) that the user may wish to buy. The server system may process the query to identify at least one product that corresponds to the query, and one or more seller listings for that product. The server system may transmit, to the buyer device, a search results page that includes one or more listings for the item for presentation to the buyer. In some implementations, a buyer may utilize a mobile device to access the online application and receive the search results page.

Often times, a seller may input unnecessary or duplicate information when providing a description for an item for sale. Such long descriptions of a product may limit a number of products included in a search results page provided for display. Specifically, buyers are using mobile devices to access the online marketplace, and it is challenging to display a long description for a product listing on a mobile screen. In some cases, the amount of data included in each search results page may vary based on the number of listings in the search results page, and the amount of data included in each listing. Specifically, the amount of data included in each listing may vary from listing to listing. The amount of data included in each search results page may also vary based on the amount of data in each listing and the number of included listings.

In particular, conventional systems may display the listings as provided by a seller when generating the listing, and the length of each listing may vary. Moreover, sellers may upload redundant information when generating a listing which may hamper the user experience for a buyer. In some cases, displaying a listing, or a search result that includes a long description, may consume screen space on a mobile device, and may impact the user experience for a buyer querying for one or more items. Additionally, search results pages may include a large amount of data due to the inputted listing having redundant or unimportant information related to an item. In some cases, transporting of the search results page including redundant information may impact network utilization. Moreover, some descriptions included by a seller in a listing may, unintentionally, negatively impact the seller's goal of selling an item at a desired price (e.g., a highest possible price).

The techniques described herein may provide for generating refined titles for a listing. The server system may employ machine learning techniques to generate a refined title of a listing to present in a search results page. The system may efficiently utilize machine learning to generate a condensed or otherwise refined title (e.g., a title of a listing) to display in listings for an item (e.g., product) available for sale. Specifically, when a listing is created, the server system may classify an item listed for sale as a listing for a particular product and may receive uploaded description for item being listed for sale. In some cases, multiple listings may be mapped to a particular product. According to one or more aspects of the present disclosure, an online marketplace may collect raw, seller-provided, titles for listings for a product and may identify user behavior data based on observing buyer behavior with the listings. The raw titles and user behavior data may be used to train a machine learning model to identify one or more parameters that may be used to refine a raw, seller-supplied, title to generate a refined title that leads to a desired outcome.

As described herein, a seller may upload a description for a listing to an online retail platform (or online marketplace) when listing an item for sale. Specifically, an online marketplace may permit a seller to create a listing to sell a product and the seller may provide their own title for the listing. A server system hosting the online marketplace may collect raw, seller-provided, titles for listings for a same product and identify user behavior data based on observing buyer behavior with the listings. In some cases, the server system may use machine learning to monitor user behavior (e.g., buyer behavior) to determine which titles for a product result in a desired outcome, and may select a refined title for a new listing based on the monitoring.

The desired outcome may be, for example, an increased likelihood of a buyer making a purchase, an increase in gross merchandise bought (GMB), or the like. For example, the server system hosting the online marketplace may monitor how often buyers click on each listing that has a seller-provided title and whether a buyer subsequently buys the listed product. The raw titles and user behavior data are used to train a machine learning model to identify one or more parameters that may be used to refine a raw, seller-supplied, title to generate a refined title that leads to a desired outcome. The desired outcome may be, for example, a shortest title for the listing that results in a high sales rate after a listing is selected by a buyer.

According to one or more aspects of the present disclosure, the machine learning model may determine a refined title for a product based on user behavior data generated for each seller uploaded title associated with listings. In an example, the machine learning model may generate the user behavior data associated with a listing based on an amount of time a prospective buyer spent viewing a listing, whether the prospective buyer actually purchased the item listed for sale, whether the prospective buyer zoomed in or otherwise manipulated the screen displaying the listing, a purchase price that the buyer paid for the listed item, or the like, or any combination thereof. The user behavior data may be a numerical value assigned to each seller uploaded title of each listing for the product. The machine learning model may identify one or more parameters based on the user behavior data. The one or more parameters identified by the machine learning model may be the impact on the desired outcome based on one or more of a total number of words in a title, including a particular word in a title, omitting a particular word from a title, substituting a particular word for a different word in a title, the order of the words in a title, or a combination thereof.

The machine learning model may generate the user behavior data associated with one or more seller provided (or uploaded) titles based on a determination of how well the user provided title was able to achieve a desired outcome (e.g., sell an item quickly for a higher price as compared to titles for other listings for the product). When generating the user behavior data, the machine learning model may normalize the user behavior data to account for any differences between listings (e.g., different title length, different descriptions, etc.). After the machine learning model is trained, a seller may input a raw title when creating a new listing for the product in an online marketplace.

The server system hosting the online marketplace may receive the raw title and may apply the trained machine learning model to generate a refined title for the listing. The machine learning model, for example, may generate the refined title by picking a number of words to include in the refined title, determining which words to keep or omit or substitute from the raw title in the refined title, and selecting the order of the words of the refined title, to generate the refined title that has a highest likelihood of achieving the desired outcome based on the machine learning training.

The online marketplace may rank the generated titles for an item to identify the best title for the item. In an example, a machine learning model ranks titles across a set of similar items and finds the best title. To select the title, the machine learning model may also monitor user interactions with the titles previously presented to a set of prospective buyers in search results pages over time to determine which title is the best for the item. In some cases, the machine learning model may also use a feedback loop in order to iteratively update the selected refined title over time.

In some examples, a prospective buyer may submit a search query to the online marketplace and the online marketplace may map the query to a particular product. When a buyer searches for that product, the online marketplace may return search results that includes one or more listings where each listing includes a refined title that is displayed, for example, on the buyer's smartphone. For example, upon receiving the search query, the online marketplace may retrieve a refined title determined for the product, and may return a search results page to the prospective buyer that includes the best title.

In some cases, the server system may also monitor the device used by the buyer and may intelligently select when to provide the refined title when serving search results. When the server system determines that the buyer is using a mobile device to access the search results, the server system may serve a search results page that includes one or more listings having refined titles. In an alternative example, when the server system determines that the buyer is using a laptop or a desktop to access the search results, the server system may serve a search results page that includes the titles of the listings as uploaded by the seller.

Providing a refined title for listings may enhance the likelihood of a desired outcome for a listing, and improve the user experience of a buyer. A refined title may also be provided for a listing in cases where the seller did not upload a title when generating a listing. Providing a refined title may be beneficial in cases where a buyer accesses the search results using a mobile device and a limited space is available for displaying the search results.

Aspects of the disclosure are initially described in the context server systems and data processing. Aspects of the disclosure are then described in the context of an application flow, a webpage, and a process flow. Aspects of the disclosure are further illustrated by and described with reference to apparatus diagrams, system diagrams, and flowcharts that relate to smart item title rewriter.

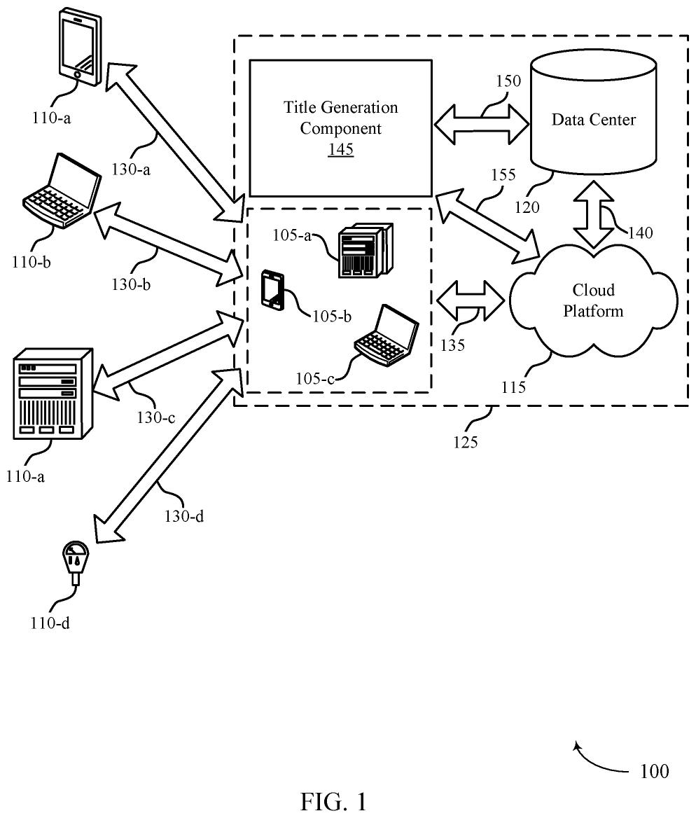

FIG. 1 illustrates an example of a system 100 that supports a smart item title rewriter in accordance with various aspects of the present disclosure. The system 100 includes cloud clients 105, user devices 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a computing device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be part of a business, an enterprise, a non-profit, a startup, or any other organization type.

A cloud client 105 may facilitate communication between the data center 120 and one or multiple user devices 110 to implement an online marketplace. The network connection 130 may include communications, opportunities, purchases, sales, or any other interaction between a cloud client 105 and a user device 110. A cloud client 105 may access cloud platform 115 to store, manage, and process the data communicated via one or more network connections 130. In some cases, the cloud client 105 may have an associated security or permission level. A cloud client 105 may have access to certain applications, data, and database information within cloud platform 115 based on the associated security or permission level, and may not have access to others.

The user device 110 may interact with the cloud client 105 over network connection 130. The network may implement transfer control protocol and internet protocol (TCP/IP), such as the Internet, or may implement other network protocols. The network connection 130 may facilitate transport of data via email, web, text messages, mail, or any other appropriate form of electronic interaction (e.g., network connections 130-a, 130-b, 130-c, and 130-d) via a computer network. In an example, the user device 110 may be computing device such as a smartphone 110-a, a laptop 110-b, and also may be a server 110-c or a sensor 110-d. In other cases, the user device 110 may be another computing system. In some cases, the user device 110 may be operated by a user or group of users. The user or group of users may be a customer, associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to-client-server systems, mobile device systems, and mobile network systems. In some cases, cloud platform 115 may support an online application. This may include support for sales between buyers and sellers operating user devices 110, service, marketing of products posted by buyers, community interactions between buyers and sellers, analytics, such as user-interaction metrics, applications (e.g., computer vision and machine learning), and the Internet of Things. Cloud platform 115 may receive data associated with generation of an online marketplace from the cloud client 105 over network connection 135, and may store and analyze the data. In some cases, cloud platform 115 may receive data directly from a user device 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or via network connection 130 between a user device 110 and the cloud client 105. Data center 120 may utilize multiple redundancies for security purposes. In some cases, the data stored at data center 120 may be backed up by copies of the data at a different data center (not pictured).

Server system 125 may include cloud clients 105, cloud platform 115, title generation component 145, and data center 120 that may coordinate with cloud platform 115 and data center 120 to implement an online marketplace. In some cases, data processing may occur at any of the components of server system 125, or at a combination of these components. In some cases, servers may perform the data processing. The servers may be a cloud client 105 or located at data center 120.

The title generation component 145 may communicate with cloud platform 115 via connection 155, and may also communicate with data center 120 via connection 150. The title generation component 145 may receive signals and inputs from user device 110 via cloud clients 105 and via cloud platform 115 or data center 140.

Some conventional systems may implement an online marketplace where a listing is displayed using a seller inputted title or description. Often times, the title provided by a seller includes unnecessary or duplicate information. In some cases, buyers may interact with such an online marketplace using a mobile device. Specifically, buyers may initiate a product search by providing a search query. In response, the online marketplace identifies a set of item listings that match the product search, and transfers the listings of the items available for sale for presentation to the prospective buyer. However, it may be challenging to display long descriptions of a product on the screen of a mobile device used by the buyer. That is, the user provided titles may limit a number of products included in a search results page provided for display, and efficient summarization techniques may be desired.

In contrast, system 100 implements procedures and techniques for generating a refined title using artificial intelligence models. Specifically, server system 125 may include operations similar to those as described herein. One or more components of server system 125, including title generation component 145, as described herein, may operate to determine which refined title to present in a search results page for a product. The title generation component 145 within server system 125 may receive, via a seller user device 110 and cloud platform 115, a set of input titles for a set of listings associated with a product. The title generation component 145 within server system 125 may also receive, via a seller user device 110 and cloud platform 115, a listing request including a suggested title for a first listing for the product. The server system 125 and title generation component 145 may generate a refined title for the first listing based on the set of input titles and the suggested title. The server system 125 and the title generation component 145 may receive, from a buyer user device 110, such as any of user devices 110, a search query that may be mapped to the product. The server system 125 and the title generation component 145 may then transmit, to the user device (e.g., any of user devices 110), a search results page in response to the search query, the search results page including the refined title for the first listing.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

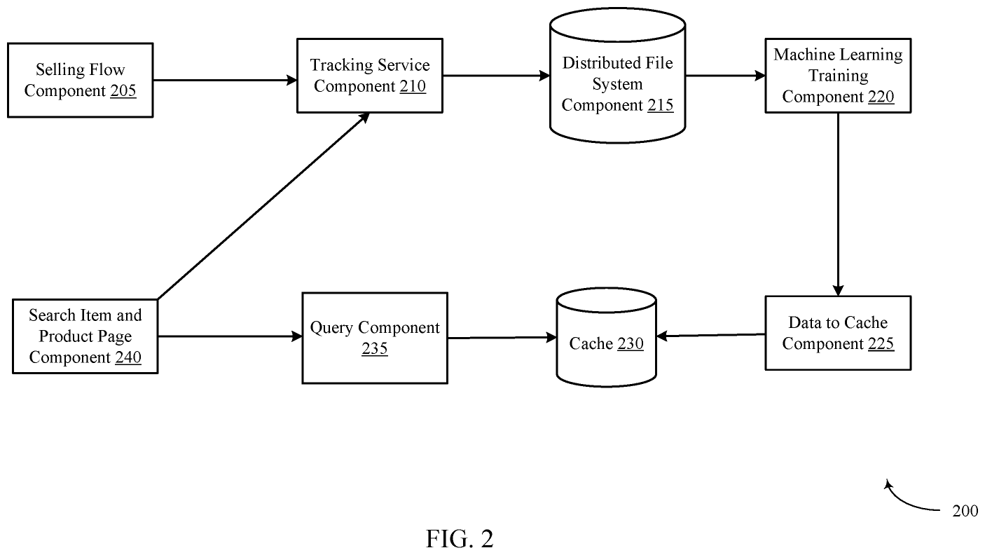

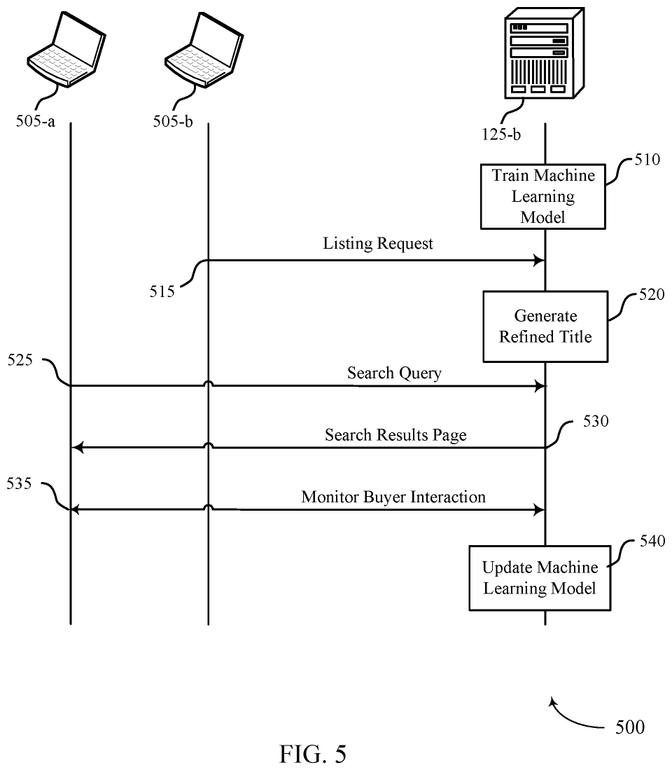

FIG. 2 illustrates an example of an application flow 200 that supports smart item title rewriter in accordance with aspects of the present disclosure. Components of the application flow 200 may include components of server system, such as server system 125 of the system 100, as described with reference to FIG. 1, or server system 125-b, as described with reference to FIG. 5, for implementing an online marketplace. Some components of application flow 200 may be within or communicating with a data center, such as data center 120, or a cloud platform, such as cloud platform 115, or both. Application flow 200 may represent a number of components used to generate a refined title for a product in order to efficiently utilize available screen space of a device used by a buyer.

Selling flow component 205 may interact with one or more users to generate listings from one or more users, or “sellers” that may intend to sell one or more items (e.g., products) via an online marketplace. The seller may be a user operating a user device, such as a user device 110 or a user device 505 as described with respect to FIGS. 1 and 5, respectively. The interaction with selling flow component 205 may prompt the seller to input a number of parameters describing the item to be listed for sale. In an example, the selling flow component 205 may cause the user device 110 to present a graphical user interface for generation of a listing. A seller may generate a listing of an item (e.g., product) for sale that includes a description of the product, and, in some cases, may upload to the selling flow component 205 one or more images of the item.

In some cases, the seller may input a title associated with the listed product. In some examples, the selling flow component 205 may suggest a product to the seller for the listing based on the description of the product provided by the seller. In some cases, the selling flow component 205 may cause the seller user device 110 to display a menu for selecting by the seller of a suggested product for the listing. In an example, a seller may interact with selling flow component 205 to generate a listing for a tablet computer, such as an Apple iPad. The specific Apple iPad listed by the seller may include further characteristics that are included in the listing. For example, the listing may include that the product for sale is an Apple iPad Air 64 GB with Wi-Fi capabilities. In one example, a title provided by a seller may include additional details such as, whether the product is new or used, whether the product is locked or unlocked, whether the product is being listed with any warranty or a combination thereof. In an example where the selling flow component 205 generates a listing for a phone, such as an Apple iPhone, a title provided by a seller may include that the product for sale is a new silver Apple iPhone X 64 GB unlocked with 12 months warranty.

The selling flow component 205 may categorize the listing as for a particular product of a set of products available to purchase via the online marketplace. A listing may be mapped to a particular product where the items listed for sale have the same or similar characteristics, but may permit some variation to exist between the items while still being mapped to the same product. In some cases, the seller generating the listing may select or recommend that the listing is for a particular product. The user-recommended product for the listing may be updated or changed by the selling flow component 205 or a machine learning training component 220.

In some examples, the selling flow component 205 may categorize a set of one or more items as being for a product by a product identification mapping process. The product identification mapping process may include an analysis of the initial product as suggested by the seller, include a confidence analysis of the accuracy of that selection based on the title, product details, analysis of mapping of similar products to a search query provided by a buyer, or the like. The product identification mapping process may also extend to other similar clusters of products using an algorithm. This product identification process may be performed by the selling flow component 205 or the machine learning training component 220. In some examples, the seller may indicate product information in the title. Alternatively, the seller may refrain from indicating the name of the product and may instead include other identifiers associated with the product (such as UPC). In such cases, the selling flow component 205 may identify the product based on prior listings associated with the same product, and may provide the seller with the product identification information (such as a product name, title of the listing, etc.)

In some examples, the selling flow component 205 or the machine learning training component 220 may generate a refined title for a listing. In one example, the selling flow component 205 or the machine learning training component 220 may execute a machine learning algorithm (e.g., neural network algorithm) to confirm that it is appropriate to categorize an item a particular product category and may generate a refined title for the item. An example of the machine learning algorithm used to generate the refined title may be a neural network, such as a pointer generator network. In an example, the machine learning algorithm may be trained using some or all listings uploaded for an item (e.g., when a listing is created or updated). In an example, items titles may be selected for a same product with the same features (e.g., condition, brand, color, etc.). The shortest title among top K popular items (e.g., frequently clicked, frequently bought by users, etc.) as the target/good title for training of a machine learning model, where K is an integer. The shortest title may be indicated as the target title of each title pair, which means each item title and the chosen title will form a pair in the training data. The other title in a title pair may be a different, seller provided title. The machine learning model may be training to determine weights for scoring words, and the relative order of words, based on the target title.

In some examples, the machine learning algorithm may be used to determine a title length distribution of one or more listings updated for an item. In some cases, the title length distribution may be used to identify a title length (e.g., in number of words) yielding the highest sale price of the item. In some examples, the title length distribution may be used to identify a title length (e.g., in number of words) yielding a quickest sale time of the item. For example, the title length distribution may indicate that an item belonging to a particular product category (e.g., cell phones and smartphones) has the highest probability of selling (e.g., at an asking price) if the length of the title is 12 words. That is, a title including 12 words has a higher chance of selling than a title including less or more words. The machine learning system may extract one or more characteristics of a prior sale of an item (e.g., price at which the item was sold, time between the listing of the item and the sale of the item, length of title of the sold item, number of offers received for the item, etc.), and determine user behavior data corresponding to the item.

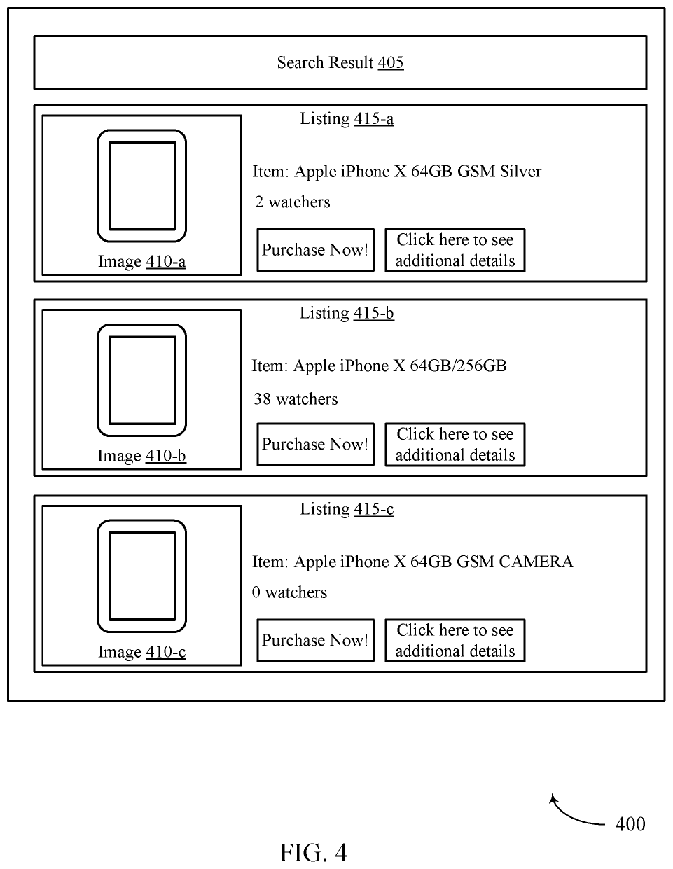

Each listing uploaded by one or more sellers may be tracked by a tracking service component 210. The tracking service component 210 may forward the listing and corresponding seller uploaded titles for storage in a distributed file system component 215. Tracking service component 210 may monitor buyer behavior when viewing one or more listings (e.g., listings including seller updated titles) in a search results pages. Examples of search results pages including listings that may be monitored are also discussed with reference to FIG. 4. Tracking service component 210 may monitor a listing presented in a search results page for purchases, as well as monitor user interaction with the product listing and communicate user behavior data to the distributed file system component 215. Distributed file system component 215 may be an example of a HADOOP application. Distributed file system component 215 may use a network of multiple computers to analyze large amounts of data. Distributed file system component 215 may monitor and analyze sales throughout the online application as well as analyze sales based on user behavior data as detected by tracking service component 210.

The machine learning training component 220 may use a machine learning model to generate a refined title for a product. The refined title may be included in a search result returned to a prospective buyer, for example, in cases where the buyer is using a mobile device and the search experience may be improved by providing a refined title for at least one listing of a set of listings for a product, instead of one or more seller uploaded titles for the listing.

The machine learning training component 220 may use a machine learning model that selects a refined title for a product based on monitoring user behavior (e.g., buyer interaction) with listings presented in a search results page to other buyers. The machine learning model may be a computer algorithm (e.g., a neural network algorithm). The machine learning training component 220 may apply the machine learning model on one or more user behavior data generated for listings of a product to identify the refined title.

In an example, a user behavior data may include a length of time that a buyer spends viewing a listing with a particular title before purchasing, or failing to purchase, the item. In some cases, user behavior data may include whether the buyer actually purchased the item listed for sale after viewing the title (e.g., a seller provided title). Additionally or alternatively, the user behavior data may include which titles of a listing are interacted with by a buyer, before purchasing, or failing to purchase, the item. For example, when a search results page is displayed to a buyer, the buyer may click on or otherwise interact with a title of a product. The user behavior data may include information (e.g., length of the title, words included in the title, order of words in the title, etc.) associated with the title interacted with by the buyer.

In one example, the user behavior data may include transaction information, such as a click rate (e.g., click through-rate for a title) and/or a sales rate (e.g., item click conversion of a particular title to a product sale) for a listing that includes a particular title. For instance, the user behavior data may record an indication of interaction between a buyer and a listing. In some examples, the buyer may click through multiple titles of listings associated with a product before purchasing, or failing to purchase the product. The user behavior data may indicate whether the buyer clicks through multiple titles of listings associated with a product before purchasing, or failing to purchase, the product. Additionally, the user behavior data may indicate a number of titles the buyer clicks through prior to buying the product.

The user behavior data may also include which title of a product a buyer clicks on first before purchasing, or failing to purchase, the product. In some examples, the user behavior data may identify a length of time that a buyer spends viewing a listing with a particular title before purchasing, or failing to purchase, the item. In one example, a user may spend a first amount of time reviewing a listing if the title of the listing includes a first number of words and spends a second amount of time reviewing the listing if the title of the listing includes a second number of words. The user behavior data may include an indication of the first number of words and the second number of words.

The user behavior data may include how many listings of a product the buyer selects to view before purchasing, or failing to purchase, the product. Additionally or alternatively, user behavior data may include a purchase price that the buyer paid for the listed item or product. In some cases, the user behavior data may include a first purchase price that a first buyer paid for a listed product after viewing a first title relative to a second purchase price a second buyer paid for the listed product after viewing a second title. In some instances, the user behavior data may include an indication of a purchase price of a product and information associated with the corresponding title of the product. One or more user behavior data may be generated for one or more of the seller uploaded titles or product descriptions, as well as other titles included in prior listings.

Tracking service component 210 may observe, over time, buyer interaction with one or more titles of one or more listings for a product presented to buyers at a graphical user interface at a buyer user device (e.g., user device 110) to generate user behavior data. Tracking service component 210 may communicate the user behavior data to the machine learning training component 220. The machine learning training component 220 may use one or more of these user behavior data or a combination of these to generate a user behavior data corresponding to each title of a listing for a product.

The machine learning training component 220 may generate the user interaction metric for a title based on a determination of how well the title was able to achieve a desired outcome (e.g., sell an item quickly for a higher price as compared to titles for other listing for a product). In some cases, the machine learning training component 220 may generate the user interaction metric based on the user behavior data. For instance, if the user behavior data indicates that a buyer has a higher probability to purchase a product when a particular word is included in the title, then the user interaction metric may apply a higher score to a title including the particular word. In some examples, the user interaction metric may apply a weighting to some or all of the one or more user behavior data to determine a numerical score that may indicate how well a title is able to achieve the desired outcome.

When generating the user interaction metric, the machine learning training component 220 may normalize the user interaction metric to account for any differences between items in the listings. The user interaction metric may be a numerical value assigned to each title of each listing for a product. The machine learning model may rank the titles available for a product based on the user interaction metrics (e.g., place in numerical order), and may determine which title characteristics provide the highest click rate and/or sale rate for a product. In some examples, training of a machine learning model by the machine learning training component 220 may be product specific, and may refine a suggested title for a listing differently for a first product (e.g., smartphone) than how a suggested title is refined for a second product (e.g., golf clubs) that differs from the first product.

In some cases, the user interaction metric (or user behavior metric) may be generated for seller uploaded titles as well as other titles provided by an organization marketing the product. In some cases, the machine learning training component 220 may generate a refined title for a product based on the user interaction metric. In some cases, the refined title may be based on the a seller uploaded title, or may be a title obtained from another source.

In one example, the machine learning training component 220 may add at least one additional word to the seller uploaded title to generate the refined title. For example, the machine learning training component 220 may determine that a particular word, when included in a title generates higher user engagement (e.g., higher score). The machine learning training component 220 may add the word to the seller uploaded title upon determining that the seller uploaded title has that particular word missing. In another example, the machine learning training component 220 may remove at least one word from the seller uploaded title to generate the refined title. In some examples, the machine learning training component 220 may substitute at least one word from the seller uploaded title to generate the refined title. For instance, the user behavior data may suggest that a buyer has a higher probability (or likelihood) to buy a product if a particular word is included in the title of the product. That is, the particular word may be associated with a higher probability score. The machine learning training component 220 may determine that seller uploaded title has a synonym of the word having the higher probability score. In such cases, the machine learning training component 220 may substitute the synonym of the word with the particular word having the higher probability score.

Additionally or alternatively, the machine learning training component 220 may determine a relative order of the words included in the seller uploaded title, and may generate the refined title by rearranging the words of the seller uploaded title according to the relative order. In some examples, the machine learning training component 220 may determine that the words in a title of a product arranged in a first order has a higher probability score (e.g., a higher probability of a buyer to purchase the product) than the words arranged in a second order. Upon receiving the seller uploaded title, the machine learning training component 220 may rearrange the words included in the seller uploaded title according to the first order. When a subsequent search query for the product is received from the same buyer or another buyer, the refined title may be included in a listing for the product presented in a search results page instead one or more seller uploaded titles for the product.

In some examples, the machine learning training component 220 may use a feedback loop in order to iteratively update the refined title over time. For example, the tracking service component 210 may receive additional user behavior data and may update the user interaction metric. The machine learning training component 220 may use the one or more updated user behavior data to generate an updated refined title for a listing, and may provide the updated refined title for display in response to receiving a subsequent search query from a buyer. In some examples, the updated refined title may result in a change the number of words to include in the refined title. For instance, the machine learning training component 220 may increase or decrease the number of words to include in a refined title, and may update a previously generated refined title accordingly. In some examples, the machine learning training component 220 may change the scoring of an order of one or more words and may generate updating an existing refined title to change the order of two or more words based on the updated scoring (e.g., updated scoring places product model information after brand name, instead of before, in the refined title). Additionally or alternatively, the machine learning training component 220 may change how scoring is assigned to a word. The machine learning training component 220 may replace one or more words in an existing refined title with one or more different words based on the updated scoring to generate the updated refined title.

Once the refined title is identified for a listing of a product, the machine learning training component 220 may forward the refined title and an identification of its product to a data to cache component 225 using a workflow management platform (e.g., Apache Airflow). The data to cache component 225 may be an example of a cache layer, such as a memory cache (e.g., memcache) or a non-structed query language (non-SQL or NOSQL) database. The data to cache component 225 may provide the refined title and an identification of its product for storage in cache 230.

When a buyer user device (e.g., user device 110) uses an online application (e.g., in an online marketplace) to transmit a search query for an item listed for sale in the online marketplace, a query component 235 may implement a service (e.g., representational state transfer (REST) service) to respond to the query. The query component 235 may query the cache 230 using the search query to identify a particular product of a set of available products and one or more listings that match the search query. In some cases, the cache 230 may return identifiers of which seller uploaded titles, and which listings, match the search query, and an identifier of a product and a corresponding refined title for each listing. In some cases, the cache 230 may indicate that a refined title is not available for a particular listing and the query component 235 may instead use the seller uploaded title or description for that particular listing. The query component 235 may use the identifiers to retrieve the seller uploaded titles, if any, and the refined titles from the distributed file system component 215.

The query component 235 may also monitor or obtain information about the buyer user device. For example, the query component 235 may determine whether the buyer device is a mobile device. The query component 235 may use the information about the user device to coordinate with a search item and product page component 240 in generating a search results page that includes the one or more listings.

In some examples, the query component 235 may determine that the buyer device is a cell phone or a device with a limited size display. If the query component 235 determines that the buyer is accessing the online application on a device having a limited size display screen (e.g., the online application is running on a mobile device as a mobile App), the search item and product page component 240 may generate the search results page to include the refined titles for one or more listings for the product, instead of any of the seller uploaded titles. The search results page may, however, include a link where the buyer user device may view the seller uploaded title (e.g., the seller uploaded title is provided when the buyer clicks on a refined title for a product). The search item and product page component 240 may then provide the search results page to the buyer user device for presentation to a prospective buyer (e.g., via a graphical user interface).

As the prospective buyer interacts with the search results page, the tracking service component 210 may coordinate with the search item and product page component 240 to monitor the behavior of the prospective buyer to update the one or more user behavior data (e.g., user click, whether user purchased a listed item after viewing the refined title, etc.) stored in the distributed file system component 215. In some examples, the machine learning training component 220 may implement a cluster-computing framework that may mine the data in the distributed file system component 215 to determine whether the refined title has resulted in a particular desired outcome (e.g., an increase in purchase likelihood). Components of the application flow 200 may thus monitor buyer behavior over time to establish a feedback loop to train (e.g., continuously train) the machine learning model for generating a refined title for a product. The tracking service component 210 may continue to collect user behavior data, and the machine learning training component 220 may iteratively update the refined title based on the updated user behavior data. The display of the refined title for a listing of a product may therefore user experience, as the refined title may provide concise and relevant information, rather than displaying long descriptions for a product, specifically when viewed on a mobile device.

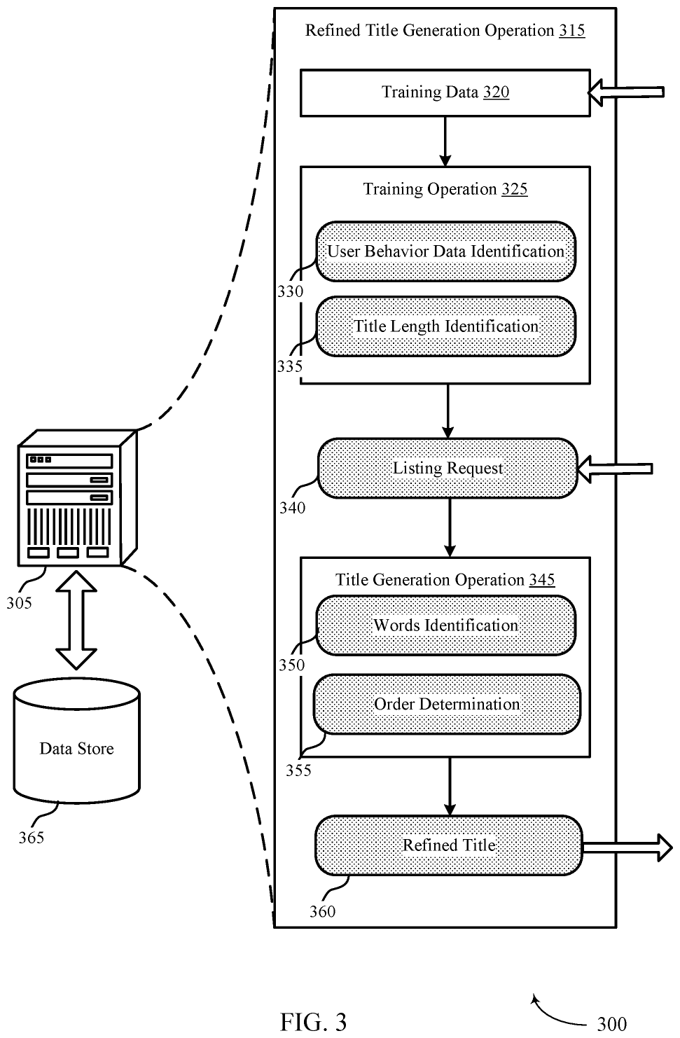

FIG. 3 illustrates an example of a system 300 that supports smart item title rewriter in accordance with aspects of the present disclosure. The system 300 may include a device 305 (e.g., an application server or server system) and a data store 365. In some cases, the functions performed by the device 305 (such as application server) may instead be performed by a component of the data store 365. A user device (not shown) may support an application for online marketplace. Specifically, a user device in combination with the device 305 may support an online marketplace that generates refined titles by using machine learning models. An application (or an application hosting the online marketplace) may train a mathematical model (e.g., artificial intelligence model) at the device 305, where the device 305 may identify results 360 based on training data and using the trained data to generate a refined title for a listing. In some examples, the device 305 may provide the results 360 to a user device (not shown).

According to one or more aspects of the present disclosure, a user device may be used by a buyer to provide a search query and receive one or more search results. Specifically, the user device may display an interactive interface for displaying an online marketplace and displaying one or more search results. In some examples, the user device may be a mobile device and may include limited size display screen. In one example, the user device may be used by a seller to upload a listing. In some cases, the interface at the user device may run as a webpage within a web browser (e.g., as a software as a service (SaaS) product). In other cases, the interface may be part of an application downloaded onto the user device. A user (seller and/or buyer) operating the user device may input information into the user interface to log on to the online marketplace. In some cases, a user may be associated with a user credential or user ID, and the user may log on to the online marketplace using the user credential.

In some cases, the device 305 may train or develop a mathematical model (e.g., artificial intelligence model, a machine learning model, a neural network model etc.) to generate a refined title. In certain aspects, the device 305 (or application server) may receive a request to develop an artificial intelligence model to generate refined titles. Additionally or alternatively, the device 305 may determine a need to develop an artificial intelligence model (e.g., machine learning model) for classifying seller uploaded descriptions and generate a refined title. As described herein, the device 305 in conjunction with the data store 365 may perform a refined title generation operation 315.

According to one or more aspects of the present disclosure, the refined title generation operation 315 may be performed by the device 305, such as a server (e.g., an application server, a database server, a server cluster, a virtual machine, a container, etc.). Although not shown in FIG. 3, the refined title generation operation 315 may be performed by a user device, a data store, or some combination of these or similar devices. In some cases, the device 305 may be a component of a subsystem 125 as described with reference to FIG. 1. The device 305 may support computer aided data science, which may be performed by an artificial intelligence-enhanced data analytics framework. The device 305 may be an example of a general analysis machine and, as such, may perform data analytics and provide a refined title based on receiving a product description from a user (e.g., seller).

According to one or more aspects of the present disclosure, the device 305 may receive training data 320 from one or more prior purchase activities. As described herein, the training data 320 may be or may include the user behavior data. For instance, the training data may include user activity based on an interaction activity associated with search results delivered to one or more user devices. For example, a user device (such as a user device separate from device 305) may receive a search results page (including multiple listings associated with a product) in response to a search query. The user device (not shown) may receive the search results page on an interactive interface. This interface may run as a webpage within a web browser, or the interface may be part of an application downloaded onto the user device. The device 305 may then receive interaction activity information associated with the search results page.

After receiving the training data 320, the device 305 may perform a training operation 325. The training operation 325 may broadly include a user behavior data identification 330 and a title length identification 335. As part of the user behavior data identification 330, the device 305 may identify a length of time that a buyer spends viewing a particular title before purchasing, or failing to purchase, the item. In one example, the device 305 may identify that a user spends a first amount of time reviewing a listing if the title of the listing includes a first number of words and spends a second amount of time reviewing the listing if the title of the listing includes a second number of words. The device 305 may identify the first number of words and the second number of words as part of the title length identification 335. In another example, the device 305 may determine whether a buyer actually purchased an item listed for sale after viewing a title. The device 305 may identify the outcome of the interaction (i.e., whether the buyer purchases or does not purchase a product) as part on the user behavior data identification 330.

Additionally or alternatively, the device 305 may identify which titles of a listing are interacted with by a buyer, before purchasing, or failing to purchase, the item. In one example, the user behavior data identification 330 may include identifying a click rate and/or a sales rate. The user behavior data identification 330 may include identifying a first purchase price that a first buyer paid for a listed product after viewing a first title relative to a second purchase price a second buyer paid for the listed product after viewing a second title. In this example, the title length identification may identify, among others, a length of the first title and a length of the second title. In some examples, the device 305 may implement a pointer-generator network to perform the training operation 325 and a title generation operation 345.

As described herein, the device 305 may receive a listing request 340 including a suggested title for a first listing for a product. For example, a seller may use a user device (such as a user device separate from device 305) to upload a listing including a suggested title (e.g., a seller defined title) for a product. The seller may provide the suggested title on an interactive interface of the user device. This interface may run as a webpage within a web browser, or the interface may be part of an application downloaded onto the user device.

Upon receiving the listing request 340, the device 305 may perform a title generation operation 345 based on the suggested title included in the listing request 340. In some examples, the title generation operation 345 may include a words identification process 350 and an order determination process 355. In one example, the device 305 may identify a set of words from the suggested title and generate a refined title based on identifying the set of words included in the suggested title. The device 305 may apply the title generation operation 345 that is, for example, a machine learning model that assigns a score to each word in the suggested title, and assigns a score to a sequence of one or more sets of words in the suggested title. For example, the device 305 may apply the words identification process 350 assign a score to each word included in the suggested title based on the likelihood of each word resulting in a desired outcome. The device 305 may apply the words identification process 350 assign a score to each sequence of one or more sets of words in the suggested title based on the likelihood of each word resulting in a desired outcome. For example, a first pair of words resulting in a sale at a higher price may be assigned a higher score as compared to a second pair of works that does not result in a sale, or in a sale at a lower price.

The device 305 may apply the title generation operation 345 to generate a refined title that results in a desired outcome, by selecting the words and their order determined to have a highest score representing a highest likelihood of a desired outcome. In one example, the device 305 may add a word from the suggested title to a refined title based on the training operation 325. For example, the device 305 may identify that if a particular word is included in a title of a listing, that listing has a higher click rate. In such a case, the device 305 may choose to add or keep the identified word (e.g., word identified during the training operation 325) in the refined title. Additionally or alternatively, the device 305 may exclude, from the refined title, a word from the suggested title based on the training operation 325. For example, the device 305 may identify a particular word in a title of a listing leads to a lower click rate or a lower sale rate. In such a case, the device 305 may choose to refrain from including the identified word (e.g., word identified during the training operation 325) in the refined title. In some cases, the device 305 may substitute a first word from the suggested title for a second word in the refined title based on the training operation 325. For instance, the device 305 may identify that a particular synonym of a word included in the suggested title has a higher click rate, sales rate, or additional user interaction than the word included in the suggested title. In such an example, the device 305 may substitute the word included in the suggested title with synonym.

As part of the order determination process 355, the device 305 may select a relative order between two or more words in the refined title based on the training operation 325. Upon performing the title generation operation 345, the device 305 may generate a refined title 360 for the listing request 340 that has a highest score, indicating a highest likelihood of a desired outcome. Table 1 provides examples of refined titles 360 generated from inputted listing requests 340.

TABLE I

| Suggested Title | Refined Title |
|---|---|
| Samsung Galaxy S7 Edge SM-G935T-32 | Samsung Galaxy S7 edge Unlocked 32 GB |
| GB-Unlocked-Android Smartphone- | Gold |
| Gold R | |
| Apple iPhone XS-64 GB-Space Gray- | Apple iPhone XS-64 GB-Space Gray |
| (Unlocked) A1920 (CDMA + GSM)-Very | (Unlocked) |
| Good | |
| Apple iPhone 6-64 GB-Silver (Verizon) | Apple iPhone 6 Verizon 64 GB Silver Used |
| A1549 (CDMA GSM) Excellent condition | |
| HUAWEI P30 LITE BLACK 64 GB 4 GB | Huawei P30 LITE Unlocked 64 GB Black |
| RAM FACTORY UNLOCKED 6.0 INCH | |
| LCD | |
| Apple iPhone 8 Plus-256 GB-Gold- | Apple iPhone 8 Plus-256 GB-Gold |
| AT&T Only-New Open Box, Free | |
| Shipping! | |

According to one or more aspects of the present disclosure, the device 305 may be configured to score certain aspects of a title based on the user behavior data. In some cases, the user behavior data may suggest that titles that lack a brand name resulted in lower, slower sales, as compared to titles including a brand name. Thus, the device 105 may use the user behavior data to apply a high score to a brand name. The device 105 may then determine to add a brand name to a refined title that was not included in the suggested title, or to maintain a brand name from the suggested title in the refined title, to increase the score for the refined title.

Additionally or alternatively, the user behavior data may suggest that sales of a product may be impacted based on where the brand name occurs within the title of the product. For example, titles with the brand name located towards the beginning first resulted in higher, quicker sales, as compared to titles where the brand name occurred later in the title. Thus, the device 105 may use the user behavior data to apply a high score when a brand name occurs earlier in a title, as compared to when a brand name occurs later, or not at all, in a title.

In some cases, the user behavior data may indicate that capitalization of some or all words resulted in lower, slower sales, as compared to only capitalizing brand names. In some cases, the device 305 may assign a higher score to some words than some other words. For example, words pertaining to brand name, model information, capabilities, product condition, and color may each be allocated a higher score. As described herein, the device 305 may perform the title generation operation 345 to score one or more words in the seller uploaded title. The device 305 may then choose one or more words for the refined title resulting in a higher or highest score than one or more words from the seller uploaded title. In some cases, the device 305 may choose one or more high scoring words to include in the refined title.

Additionally or alternatively, the device 305 may identify how many words to include in the refined title based on the user behavior data. For example, the device 305 may determine, using machine learning, that a title with 6 words results in a highest likelihood of a desired outcome, and that titles with more or fewer words result in lower likelihoods of a desired outcome. The device 305 may apply machine learning to the suggested title to select the 6 words from the suggested title, or one or more word replacements, resulting in the highest assigned scores. The device 305 may also apply machine learning to the selected 6 words to identify a sequence for those words resulting in a highest assigned score. In this example, the device 305 may output the refined title as the selected 6 words in the sequence resulting in the highest assigned score.

In an example with reference to Table 1, the device 305 may receive a seller uploaded title “Samsung Galaxy S7 Edge SM-G935T-32 GB-Unlocked-Android Smartphone-Gold R.” Upon receiving the seller uploaded title, the device 305 may determine that the words “Samsung,” “Galaxy S7 Edge,” “32 GB,” “Unlocked,” and “Gold” have higher scores than the remaining words. These selected words may correspond to brand information (e.g., Samsung), product model information (e.g., Galaxy S7 Edge), a locked status to a particular carrier (e.g., unlocked), device capability information (e.g., device has a storage capacity of 32 GB), product color (e.g., Gold), or the like. The device 305 may also applying machine learning to determine that the order of these words shown in the refined title of Table 1 results in a higher likelihood of a desired outcome as compared to other orders for these words.

Additionally, the device 305 may determine an order of the words to be included in the refined title. For instance, the device 305 may determine that the word “Unlocked” is to appear prior to the word “32 GB” in the refined title. The device 305 may then generate the refined title as “Samsung Galaxy S7 edge Unlocked 32 GB Gold.” As depicted, certain words from the suggested title are not included in the refined title, such as operating system information (e.g., “Android Smartphone”) or product condition (e.g., excellent), due to, for example, having a lower assigned score than the other words in the suggested title, resulting in a lower likelihood of a desired outcome, or both.

In another example included in Table 1, the device 305 may receive a seller uploaded title “HUAWEI P30 LITE BLACK 64 GB 4 GB RAM FACTORY UNLOCKED 6.0 INCH LCD.” As described herein, the user behavior data may indicate that capitalization of some or all words resulted in lower, slower sales. Accordingly, the device 305 may remove any capitalization some or all letters in one or more words and may generate the refined title as “Huawei P30 LITE Unlocked 64 GB Black.”

FIG. 4 illustrates an example of a search results webpage 400 that supports smart item title rewriter in accordance with aspects of the present disclosure. Webpage 400 may be an example of a page displaying search results based on a buyer-inputted search query. Webpage 400 may be displayed to a prospective buyer at a user device (e.g., user device 110) at a tablet, smartphone, or another client-facing user device.

A buyer may access an online application (e.g., a website or a smart-phone app) of an online marketplace (e.g., presented by search item and product page component 240) and input a search query. In an example, the buyer may enter a search for purchasing a tablet computer. In an example, a buyer may input “Apple iPhone X” as a search query. The search query may result in the display at the buyer user device of a search result 405 that includes one or more listings 415. The one or more listings 415 may include refined titles instead of seller provided titles.

As depicted in the FIG. 4, each listing may include an image 410 associated with the listing. Search result 405 may include one or more listings generated by sellers (e.g., users utilizing a user device 110 to interact with a selling flow component 205) that relate to the search query input by the buyer. An example listing 415 may include information about the item for sale (e.g., Apple iPhone X 64 GB GSM Silver), a number of watchers interested in the item, a price for the item (e.g., if using a purchase now feature), an option to view additional details (e.g., seller uploaded details) for the item, or the like. In the depicted example, the search result 405 includes listings 415-a, 415-b, and 415-c, and each listing is associated with a same product (e.g., a “Apple iPhone X” product). In some cases, each item referenced in a listing 415 may be for a same product, but may have some features that may vary from other listings for the product. For example, the color of a housing for the mobile phone may be different for some of the items, but each mobile phone may be the same model number (e.g., iPhone X) and have a same storage capacity (e.g., 64 GB).

A same seller or a set of sellers may have generated the listings 415-a, 415-b, and 415-c. One or more sellers, when generating the listing 415-a, 415-b, and 415-c, may have uploaded titles or listing description for each listing 415. For example, listing 415-a may be for a mobile phone and may include the refined title “Apple iPhone X 64 GB GSM Silver”. The seller may have uploaded a title for listing 415-a that recites “NEW OTHER Apple iPhone X 64 GB Silver GSM Unlocked AT&T T-Mobile Compatible.” Listing 415-b may be for a mobile phone and may include the refined title “Apple iPhone X 64 GB/256 GB”. The seller may have uploaded a title for listing 415-b that recites “Apple iPhone X-64 GB 256 GB-Unlocked SIM Free Smartphone-12 m Warranty.” Additionally, listing 415-c may be for a mobile phone and may include the refined title “Apple iPhone X 64 GB GSM Camera”. The seller may have uploaded a title for listing 415-c that recites “Apple iPhone X-64 GB-Space Gray Unlocked A1901 GSM/w Bonus Camera.”

In the depicted example, an image 410 is displayed along with each listing 415, and images 410-a, 410-b, and 410-c are shown. The images 410-a, 410-b, and 410-c may be, for example, a thumb-nail sized version of an image, and the buyer may select to display a larger version of the same image. The machine learning techniques described herein may be used to generate and display a refined title for a product. For example, each of listings 415-a, 415-b, and 415-c may each include refined titles. In some cases, each of listings 415-a, 415-b, and 415-c may be associated with the same product. In some cases, a seller may upload a description when generating a listing 415. Alternatively, a seller may not upload any description when generating the listing 415. In some cases, the search results page 405 may include the refined title for that listing. For example, listing 415-c may be refined from a seller uploaded title “Apple iPhone X-64 GB-Space Gray Unlocked A1901 GSM/w Bonus Camera” (displaying “Apple iPhone X 64 GB GSM Camera” instead of the user provided title). In some examples, the search results page 405 may display listings 415 from multiple products, and a first subset of listings (e.g., listings 415-a, 415-b) may each display a first refined title for a first product of the multiple products, and a second subset of listings (e.g., listing 415-c) may display a second refined title of a second product of the multiple products, where the first and second refined titles differ.

FIG. 5 illustrates an example of a process flow 500 that supports smart item title rewriter in accordance with aspects of the present disclosure. Process flow 500 may include a server system 125-b, a buyer user device 505-a, and a seller user device 505-b. Server system 125-b may be an example of server system 125 as described with reference to FIG. 1. Buyer user device 505-a and seller user device 505-b may be example of a user device 110 as described with reference to FIG. 1. Seller user device 505-b may be a device that a seller uses to generate a listing for an item for sale via an online marketplace, and may have the option to upload description of the item when creating the listing. Buyer user device 505-a may be a device that a prospective buyer may use to access the online marketplace, such as via a smart-phone app or a website, to search for items listed for sale and to complete purchase transactions.

At 510, the server system 125-b may receive user behavior data including click rate data, sales rate data, or both. For example, the server system 125-b may receive a mapping between a title of a listing and user behavior data associated with that listing. The server system 125-b may train a machine learning model based on user behavior data corresponding to the set of listings. For instance, the server system 125-b may train the machine learning model based on the received user behavior data corresponding to a set of prior listings for a same product, or for multiple products. In some cases, the server system 125-b may collect the user behavior data and may utilize the user behavior data to train the machine learning model. For example, the user behavior data may be used to train the machine learning model to achieve a desired outcome. In one example, identifying the user behavior data may include the server system 125-b identifying a duration of time that a buyer spends viewing a particular title before purchasing, or failing to purchase, the item. In one example, the server system 125-b may identify that a user spends a first amount of time reviewing a listing if the title of the listing includes a first number of words and spends a second amount of time reviewing the listing if the title of the listing includes a second number of words. In some cases, the first amount of time and/or the second amount of time may be stored as the user behavior data. The server system 125-b may determine whether a buyer actually purchased an item listed for sale after viewing a title. For instance, if the buyer purchases the item, then the server system 125-b may store the purchase event as the user behavior data.

At 515, server system 125-b may receive a listing request including a suggested title for a first listing for the product. For example, at least one seller user device 505-b may interact with the server system 125-b to generate at least one listing for at least one item for sale via an online marketplace. For each listing, the server system 125-b may permit the seller user device 505-b to upload a description of an item being listed for sale in a listing, including a suggested title for the item. In some examples, the listing request may include a set of words as the suggested title.

At 520, the server system 125-b may generate a refined title for the first listing (i.e., the listing included in the listing request received from the seller device 505-b). For example, the server system 125-b may generate the refined title for the first listing based on the set of input titles used to train the machine learning model and the suggested title included in the listing request. In one example, the server system 125-b may identify a set of words in a suggested title received in the listing request. The server system 125-b may assign a score to each word and a score to the order of one or more subsets of the words in the suggested title. The server system 125-b may then apply machine learning to generate a refined title that has a highest likelihood of a desired outcome based on the suggested title. For example, the server system 125-b may apply machine learning to select a number of words to include in the refined title. In an example, the server system 125-b may add a word from the set of identified words to the refined title based on the machine learning model trained at 510. Additionally or alternatively, the server system 125-b may identify a set of words in the listing request, and may exclude, from the refined title, a word from the set of identified words based on the machine learning model (e.g., that is assigned a low score, reduces the likelihood of a desired outcome, etc.). In some examples, the server system 125-b may generate the refined title by selecting a relative order between two or more words in the refined title based on the machine learning model (e.g., the machine learning model trained at 510). In some examples, the server system 125-b may generate the refined title by substituting a first word from the suggested title for a second word to be include in the refined title that increases the likelihood of a desired outcome based on the machine learning model.

At 525, the server system 125-b may receive, from buyer user device 505-a, a search query that may be mapped to the product. The server system 125-b may map the search query to the product where the text input into the search query best matches the product. The server system 125-b may receive, from the buyer user device 505-a, or another user device, a second search query that may be mapped to the product.

At 530, the server system 125-b may transmit, to buyer user device 505-a, a query response that includes the refined title for the first listing for the product. For example, the server system 125-b may transmit a search results page that includes at least the first listing and the refined title for the first listing. In some examples, the server system 125-b may transmit, to buyer user device 505-a, the search results page that includes a first refined title for a listing associated with a first item and a second refined title for a listing associated with a second item. The first and second items may be a same product offered for sale by different sellers.

At 535, server system 125-b may monitor buyer interaction with the search results page as described herein. The server system 125-b may update user behavior data based on user interaction (based on user behavior data) with the search results page, and may apply machine learning to the updated user behavior data.

At 540, server system 125-b may update the machine learning model based on monitoring the buyer interaction with the search results page. In some cases, the server system 125-b may keep the same refined title for a listing, or may change to a different refined title (or updated refined title) for the listing based on the updated machine learning model. For instance, the updated refined title may have one or more words added, excluded or substituted from an existing title. Additionally or alternatively, an order of words in the updated refined title may be different from an order of words in an existing title.

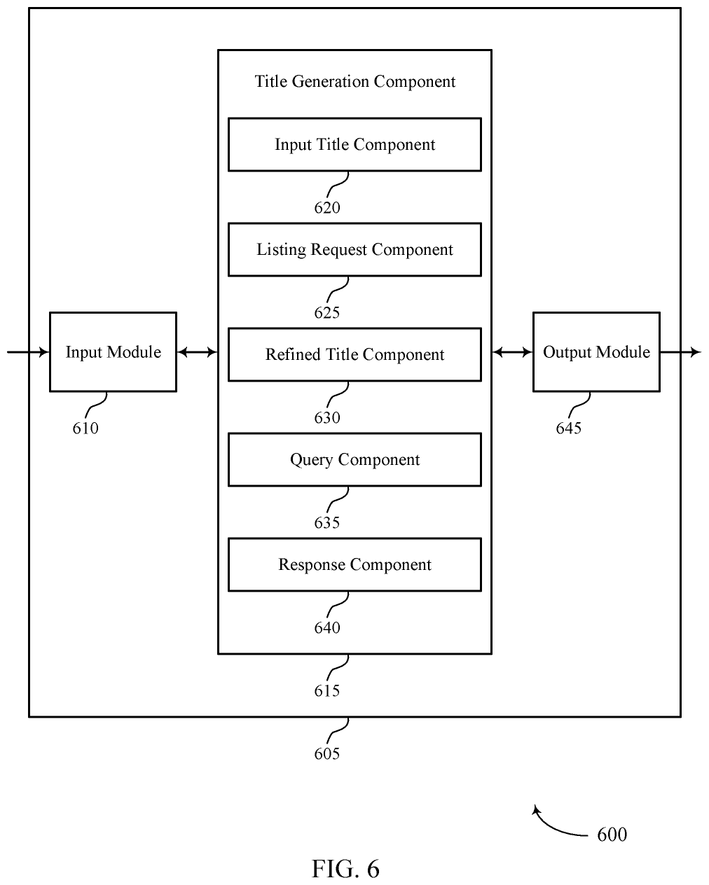

FIG. 6 shows a block diagram 600 of an apparatus 605 that supports smart item title rewriter in accordance with aspects of the present disclosure. The apparatus 605 may include an input module 610, a title generation component 615, and an output module 645. The apparatus 605 may also include a processor. Each of these components may be in communication with one another (e.g., via one or more buses). In some cases, the apparatus 605 may be an example of a user terminal, a database server, or a system containing multiple computing devices. In some cases, the apparatus 605 may be used to generate and provide refined titles for recommendations in a display page including multiple items. Additionally or alternatively, the apparatus 605 may refine titles for advertisements for various social media platforms. In some cases, the apparatus 605 may be utilized to generate refined titles to rewrite null and low search queries to improve recall size.

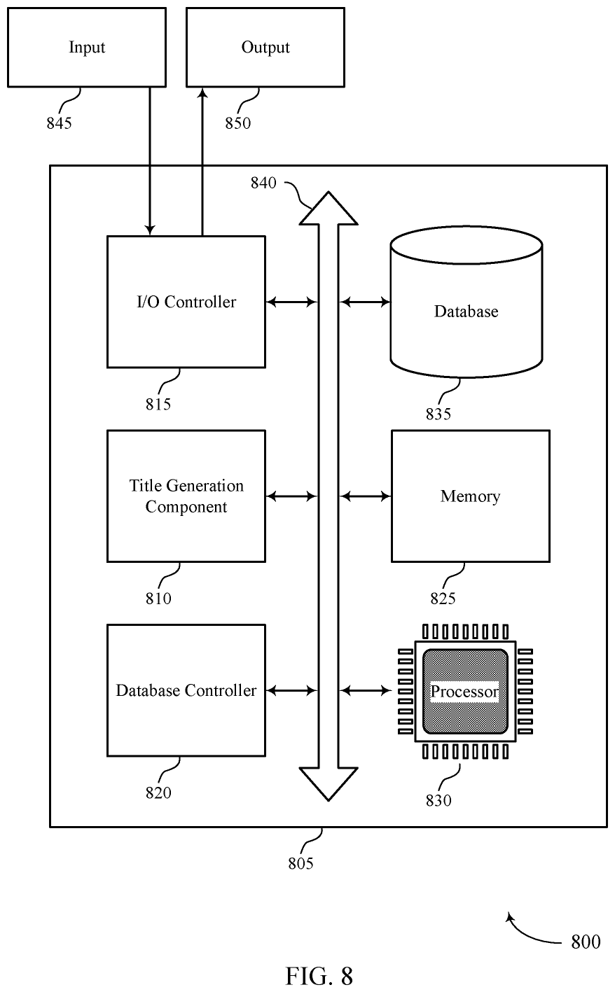

The input module 610 may manage input signals for the apparatus 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the apparatus 605 for processing. For example, the input module 610 may transmit input signals to the data retention module 615 to support data retention handling for data object stores. In some cases, the input module 610 may be a component of an input/output (I/O) controller 815 as described with reference to FIG. 8.

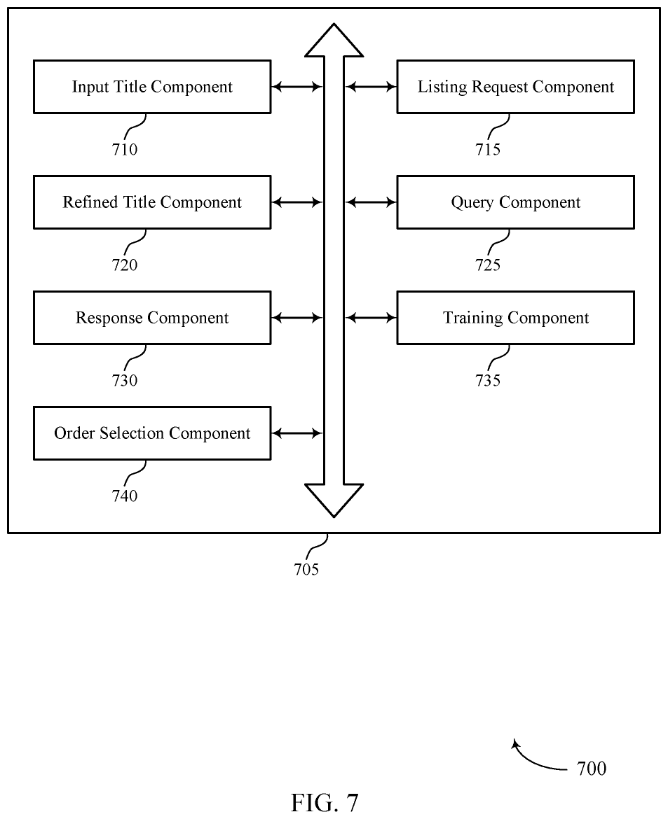

The title generation component 615 may include an input title component 620, a listing request component 625, a refined title component 630, a query component 635, and a response component 640. The title generation component 615 may be an example of aspects of the title generation component 705 or 810 described with reference to FIGS. 7 and 8.

The title generation component 615 and/or at least some of its various sub-components may be implemented in hardware, software executed by a processor, firmware, or any combination thereof. If implemented in software executed by a processor, the functions of the title generation component 615 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The title generation component 615 and/or at least some of its various sub-components may be physically located at various positions, including being distributed such that portions of functions are implemented at different physical locations by one or more physical devices. In some examples, the title generation component 615 and/or at least some of its various sub-components may be a separate and distinct component in accordance with various aspects of the present disclosure. In other examples, the title generation component 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The input title component 620 may receive a set of input titles for a set of listings associated with a product. The listing request component 625 may receive a listing request including a suggested title for a first listing for the product. The refined title component 630 may generate a refined title for the first listing based on the set of input titles and the suggested title. The query component 635 may receive a query that is mapped to the product. The response component 640 may transmit a query response that includes the refined title for the first listing based on the search query.

The output module 645 may manage output signals for the apparatus 605. For example, the output module 645 may receive signals from other components of the apparatus 605, such as the data retention module 615, and may transmit these signals to other components or devices. In some specific examples, the output module 645 may transmit output signals for display in a user interface, for storage in a database or data store, for further processing at a server or server cluster, or for any other processes at any number of devices or systems. In some cases, the output module 645 may be a component of an I/O controller 815 as described with reference to FIG. 8.

FIG. 7 shows a block diagram 700 of a title generation component 705 that supports smart item title rewriter in accordance with aspects of the present disclosure. The title generation component 705 may be an example of aspects of a title generation component 615 or a title generation component 810 described herein. The title generation component 705 may include an input title component 710, a listing request component 715, a refined title component 720, a query component 725, a response component 730, a training component 735, and an order selection component 740. Each of these modules may communicate, directly or indirectly, with one another (e.g., via one or more buses).

The input title component 710 may receive a set of input titles for a set of listings associated with a product. The listing request component 715 may receive a listing request including a suggested title for a first listing for the product.

The refined title component 720 may generate a refined title for the first listing based on the set of input titles and the suggested title. The query component 725 may receive a query that is mapped to the product. The response component 730 may transmit a query response that includes the refined title for the first listing based on the search query.

The training component 735 may train a machine learning model based on user behavior data corresponding to the set of listings, where the refined title is generated based on the machine learning model. In some examples, the training component 735 may receive the user behavior data including click rate data, sales rate data, or both. In some examples, the training component 735 may train the machine learning model based on the received user behavior data.

In some examples, the refined title component 720 may identify a set of words in the listing request including the suggested title. In some examples, the refined title component 720 may add a word from the set of words to the refined title based on the machine learning model.

The order selection component 740 may select a relative order between two or more words in the refined title based on the machine learning model. In some examples, the refined title component 720 may exclude, from the refined title, a word from the set of words based on the machine learning model. In some examples, the refined title component 720 may substitute a first word from the suggested title for a second word in the refined title based on the machine learning model.

FIG. 8 shows a diagram of a system 800 including a device 805 that supports smart item title rewriter in accordance with aspects of the present disclosure. The device 805 may be an example of or include the components of a server system or an apparatus 605 as described herein. The device 805 may include components for bi-directional data communications including components for transmitting and receiving communications, including a title generation component 810, an I/O controller 815, a database controller 820, memory 825, a processor 830, and a database 835. These components may be in electronic communication via one or more buses (e.g., bus 840).

The title generation component 810 may be an example of a title generation component 615 or 705 as described herein. For example, the title generation component 810 may perform any of the methods or processes described above with reference to FIGS. 6 and 7. In some cases, the title generation component 810 may be implemented in hardware, software executed by a processor, firmware, or any combination thereof.

The I/O controller 815 may manage input signals 845 and output signals 850 for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The database controller 820 may manage data storage and processing in a database 835. In some cases, a user may interact with the database controller 820. In other cases, the database controller 820 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause the processor to perform various functions described herein. In some cases, the memory 825 may contain, among other things, a basic input/output system (BIOS) which may control basic hardware or software operation such as the interaction with peripheral components or devices.

The processor 830 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting smart item title rewriter).

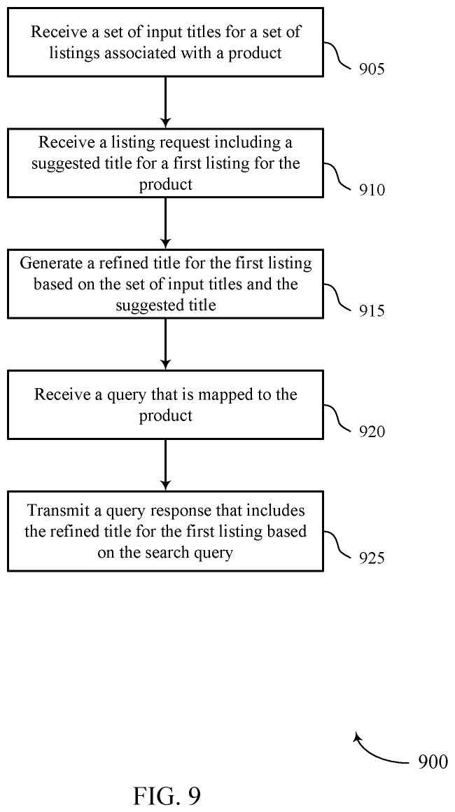

FIG. 9 shows a flowchart illustrating a method 900 that supports smart item title rewriter in accordance with aspects of the present disclosure. The operations of method 900 may be implemented by a server system or its components as described herein. For example, the operations of method 900 may be performed by a title generation component as described with reference to FIGS. 6 through 8. In some examples, a server system may execute a set of instructions to control the functional elements of the server system to perform the functions described below. Additionally or alternatively, a server system may perform aspects of the functions described below using special-purpose hardware.

At 905, the server system may receive a set of input titles for a set of listings associated with a product. The operations of 905 may be performed according to the methods described herein. In some examples, aspects of the operations of 905 may be performed by an input title component as described with reference to FIGS. 6 through 8.

At 910, the server system may receive a listing request including a suggested title for a first listing for the product. The operations of 910 may be performed according to the methods described herein. In some examples, aspects of the operations of 910 may be performed by a listing request component as described with reference to FIGS. 6 through 8.

At 915, the server system may generate a refined title for the first listing based on the set of input titles and the suggested title. The operations of 915 may be performed according to the methods described herein. In some examples, aspects of the operations of 915 may be performed by a refined title component as described with reference to FIGS. 6 through 8.

At 920, the server system may receive a query that is mapped to the product. The operations of 920 may be performed according to the methods described herein. In some examples, aspects of the operations of 920 may be performed by a query component as described with reference to FIGS. 6 through 8.

At 925, the server system may transmit a query response that includes the refined title for the first listing based on the search query. The operations of 925 may be performed according to the methods described herein. In some examples, aspects of the operations of 925 may be performed by a response component as described with reference to FIGS. 6 through 8.

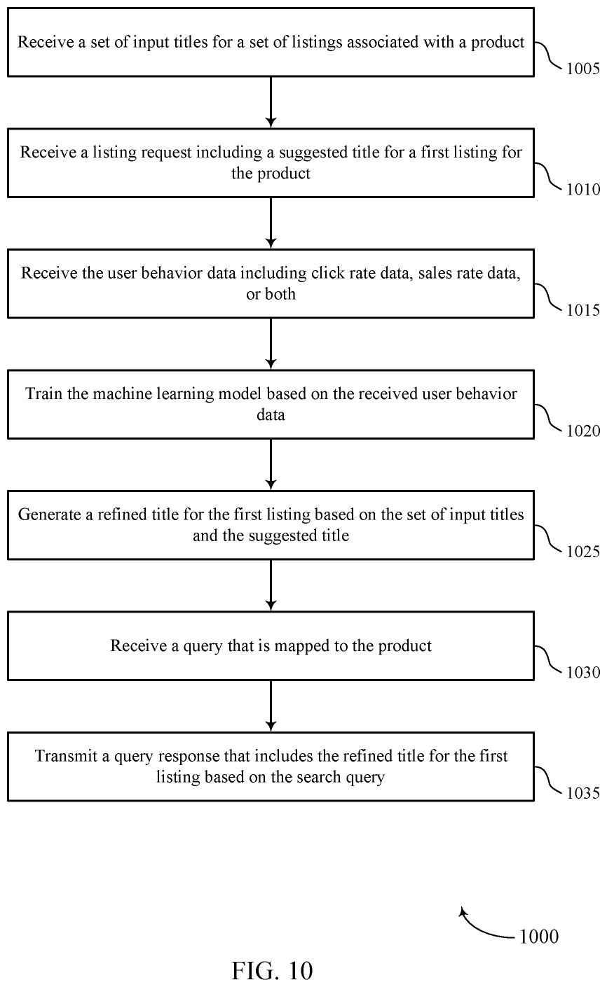

FIG. 10 shows a flowchart illustrating a method 1000 that supports smart item title rewriter in accordance with aspects of the present disclosure. The operations of method 1000 may be implemented by a server system or its components as described herein. For example, the operations of method 1000 may be performed by a title generation component as described with reference to FIGS. 6 through 8. In some examples, a server system may execute a set of instructions to control the functional elements of the server system to perform the functions described below. Additionally or alternatively, a server system may perform aspects of the functions described below using special-purpose hardware.

At 1005, the server system may receive a set of input titles for a set of listings associated with a product. The operations of 1005 may be performed according to the methods described herein. In some examples, aspects of the operations of 1005 may be performed by an input title component as described with reference to FIGS. 6 through 8.

At 1010, the server system may receive a listing request including a suggested title for a first listing for the product. The operations of 1010 may be performed according to the methods described herein. In some examples, aspects of the operations of 1010 may be performed by a listing request component as described with reference to FIGS. 6 through 8.

At 1015, the server system may receive the user behavior data including click rate data, sales rate data, or both. The operations of 1015 may be performed according to the methods described herein. In some examples, aspects of the operations of 1015 may be performed by a training component as described with reference to FIGS. 6 through 8.

At 1020, the server system may train the machine learning model based on the received user behavior data. The operations of 1020 may be performed according to the methods described herein. In some examples, aspects of the operations of 1020 may be performed by a training component as described with reference to FIGS. 6 through 8.

At 1025, the server system may generate a refined title for the first listing based on the set of input titles and the suggested title. The operations of 1025 may be performed according to the methods described herein. In some examples, aspects of the operations of 1025 may be performed by a refined title component as described with reference to FIGS. 6 through 8.

At 1030, the server system may receive a query that is mapped to the product. The operations of 1030 may be performed according to the methods described herein. In some examples, aspects of the operations of 1030 may be performed by a query component as described with reference to FIGS. 6 through 8.

At 1035, the server system may transmit a query response that includes the refined title for the first listing based on the search query. The operations of 1035 may be performed according to the methods described herein. In some examples, aspects of the operations of 1035 may be performed by a response component as described with reference to FIGS. 6 through 8.

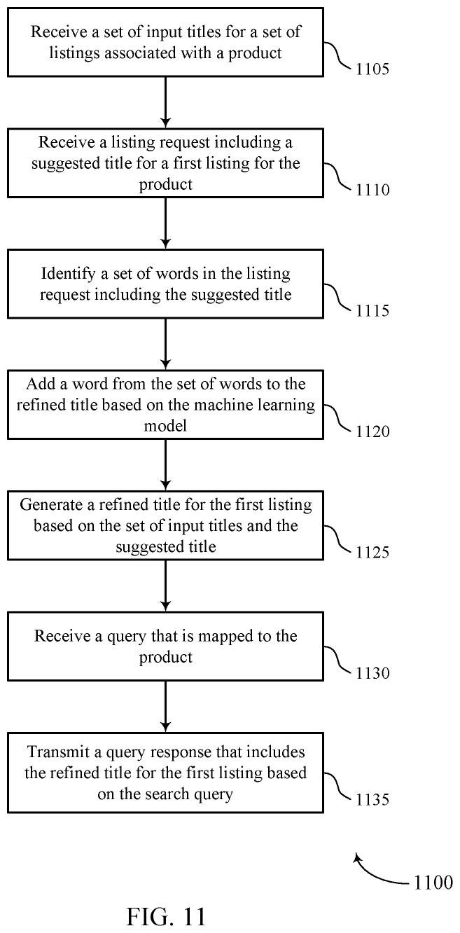

FIG. 11 shows a flowchart illustrating a method 1100 that supports smart item title rewriter in accordance with aspects of the present disclosure. The operations of method 1100 may be implemented by a server system or its components as described herein. For example, the operations of method 1100 may be performed by a title generation component as described with reference to FIGS. 6 through 8. In some examples, a server system may execute a set of instructions to control the functional elements of the server system to perform the functions described below. Additionally or alternatively, a server system may perform aspects of the functions described below using special-purpose hardware.

At 1105, the server system may receive a set of input titles for a set of listings associated with a product. The operations of 1105 may be performed according to the methods described herein. In some examples, aspects of the operations of 1105 may be performed by an input title component as described with reference to FIGS. 6 through 8.

At 1110, the server system may receive a listing request including a suggested title for a first listing for the product. The operations of 1110 may be performed according to the methods described herein. In some examples, aspects of the operations of 1110 may be performed by a listing request component as described with reference to FIGS. 6 through 8.

At 1115, the server system may identify a set of words in the listing request including the suggested title. The operations of 1115 may be performed according to the methods described herein. In some examples, aspects of the operations of 1115 may be performed by a refined title component as described with reference to FIGS. 6 through 8.

At 1120, the server system may add a word from the set of words to the refined title based on the machine learning model. The operations of 1120 may be performed according to the methods described herein. In some examples, aspects of the operations of 1120 may be performed by a refined title component as described with reference to FIGS. 6 through 8.

At 1125, the server system may generate a refined title for the first listing based on the set of input titles and the suggested title. The operations of 1125 may be performed according to the methods described herein. In some examples, aspects of the operations of 1125 may be performed by a refined title component as described with reference to FIGS. 6 through 8.

At 1130, the server system may receive a query that is mapped to the product. The operations of 1130 may be performed according to the methods described herein. In some examples, aspects of the operations of 1130 may be performed by a query component as described with reference to FIGS. 6 through 8.

At 1135, the server system may transmit a query response that includes the refined title for the first listing based on the search query. The operations of 1135 may be performed according to the methods described herein. In some examples, aspects of the operations of 1135 may be performed by a response component as described with reference to FIGS. 6 through 8.

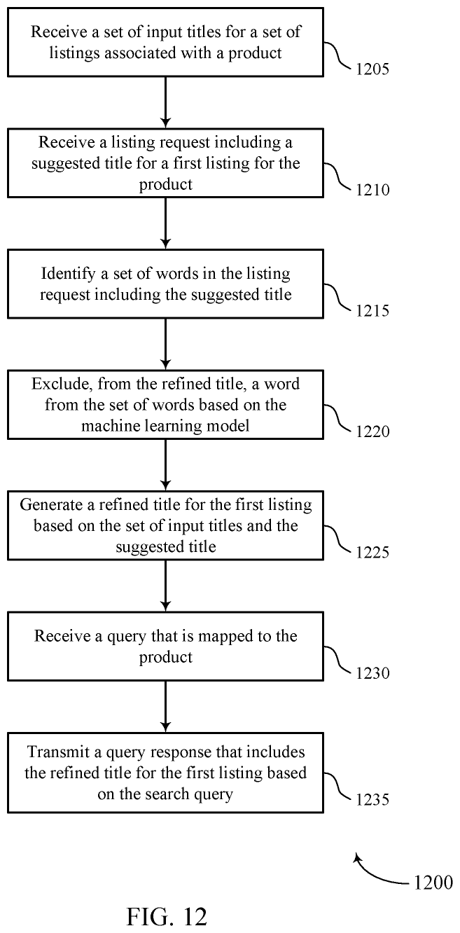

FIG. 12 shows a flowchart illustrating a method 1200 that supports smart item title rewriter in accordance with aspects of the present disclosure. The operations of method 1200 may be implemented by a server system or its components as described herein. For example, the operations of method 1200 may be performed by a title generation component as described with reference to FIGS. 6 through 8. In some examples, a server system may execute a set of instructions to control the functional elements of the server system to perform the functions described below. Additionally or alternatively, a server system may perform aspects of the functions described below using special-purpose hardware.

At 1205, the server system may receive a set of input titles for a set of listings associated with a product. The operations of 1205 may be performed according to the methods described herein. In some examples, aspects of the operations of 1205 may be performed by an input title component as described with reference to FIGS. 6 through 8.

At 1210, the server system may receive a listing request including a suggested title for a first listing for the product. The operations of 1210 may be performed according to the methods described herein. In some examples, aspects of the operations of 1210 may be performed by a listing request component as described with reference to FIGS. 6 through 8.

At 1215, the server system may identify a set of words in the listing request including the suggested title. The operations of 1215 may be performed according to the methods described herein. In some examples, aspects of the operations of 1215 may be performed by a refined title component as described with reference to FIGS. 6 through 8.

At 1220, the server system may exclude, from the refined title, a word from the set of words based on the machine learning model. The operations of 1220 may be performed according to the methods described herein. In some examples, aspects of the operations of 1220 may be performed by a refined title component as described with reference to FIGS. 6 through 8.

At 1225, the server system may generate a refined title for the first listing based on the set of input titles and the suggested title. The operations of 1225 may be performed according to the methods described herein. In some examples, aspects of the operations of 1225 may be performed by a refined title component as described with reference to FIGS. 6 through 8.

At 1230, the server system may receive a query that is mapped to the product. The operations of 1230 may be performed according to the methods described herein. In some examples, aspects of the operations of 1230 may be performed by a query component as described with reference to FIGS. 6 through 8.

At 1235, the server system may transmit a query response that includes the refined title for the first listing based on the search query. The operations of 1235 may be performed according to the methods described herein. In some examples, aspects of the operations of 1235 may be performed by a response component as described with reference to FIGS. 6 through 8.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method for generating a refined title of a listing for a product, comprising:
receiving a plurality of input titles for a plurality of listings associated with a product;
receiving a listing request including a suggested title for a first listing for the product;
generating a refined title for the first listing based at least in part on the plurality of input titles and the suggested title;
receiving a query that is mapped to the product; and
transmitting a query response that includes the refined title for the first listing based at least in part on the search query.

2. The method of claim 1, further comprising:
training a machine learning model based at least in part on user behavior data corresponding to the plurality of listings, wherein the refined title is generated based at least in part on the machine learning model.

3. The method of claim 2, wherein training the machine learning model further comprises:
receiving the user behavior data comprising click rate data, sales rate data, or both; and
training the machine learning model based at least in part on the received user behavior data.

4. The method of claim 1, wherein generating the refined title comprises:
identifying a plurality of words in the listing request including the suggested title; and
adding a word from the plurality of words to the refined title based at least in part on the machine learning model.

5. The method of claim 1, wherein generating the refined title comprises:
identifying a plurality of words in the listing request including the suggested title; and
excluding, from the refined title, a word from the plurality of words based at least in part on the machine learning model.

6. The method of claim 1, wherein generating the refined title comprises:
selecting a relative order between two or more words in the refined title based at least in part on the machine learning model.

7. The method of claim 1, wherein generating the refined title comprises:
substituting a first word from the suggested title for a second word in the refined title based at least in part on the machine learning model.

8. An apparatus for generating a refined title of a listing for a product, comprising:
a processor,
memory coupled with the processor; and
instructions stored in the memory and executable by the processor to cause the apparatus to:
receive a plurality of input titles for a plurality of listings associated with a product;
receive a listing request including a suggested title for a first listing for the product;
generate a refined title for the first listing based at least in part on the plurality of input titles and the suggested tide;
receive a query that is mapped to the product; and
transmit a query response that includes the refined title for the first listing based at least in part on the search query.

9. The apparatus of claim 8, wherein the instructions are further executable by the processor to cause the apparatus to:
train a machine learning model based at least in part on user behavior data corresponding to the plurality of listings, wherein the refined title is generated based at least in part on the machine learning model.

10. The apparatus of claim 46, wherein the instructions to train the machine learning model further are executable by the processor to cause the apparatus to:
receive the user behavior data comprising click rate data, sales rate data, or both; and
train the machine learning model based at least in part on the received user behavior data.

11. The apparatus of claim 8, wherein the instructions to generate the refined title are executable by the processor to cause the apparatus to:
identify a plurality of words in the listing request including the suggested title; and
add a word from the plurality of words to the refined title based at least in part on the machine learning model.

12. The apparatus of claim 8, wherein the instructions to generate the refined title are executable by the processor to cause the apparatus to:
identify a plurality of words in the listing request including the suggested title; and
exclude, from the refined title, a word from the plurality of words based at least in part on the machine learning model.

13. The apparatus of claim 8, wherein the instructions to generate the refined title are executable by the processor to cause the apparatus to:
select a relative order between two or more words in the refined title based at least in part on the machine learning model.

14. The apparatus of claim 8, wherein the instructions to generate the refined title are executable by the processor to cause the apparatus to:
substitute a first word from the suggested title for a second word in the refined title based at least in part on the machine learning model.

15. A non-transitory computer-readable medium storing code for generating a refined title of a listing for a product, the code comprising instructions executable by a processor to:
receive a plurality of input tides for a plurality of listings associated with a product;
receive a listing request including a suggested title for a first listing for the product;
generate a refined title for the first listing based at least in part on the plurality of input titles and the suggested title;
receive a query that is mapped to the product; and
transmit a query response that includes the refined title for the first listing based at least in part on the search query.

16. The non-transitory computer-readable medium of claim 15, wherein the instructions are further executable to:
train a machine learning model based at least in part on user behavior data corresponding to the plurality of listings, wherein the refined title is generated based at least in part on the machine learning model.

17. The non-transitory computer-readable medium of claim 16, wherein the instructions to train the machine learning model further are executable to:
receive the user behavior data comprising click rate data, sales rate data, or both; and
train the machine learning model based at least in part on the received user behavior data.

18. The non-transitory computer-readable medium of claim 15, wherein the instructions to generate the refined title are executable to:
identify a plurality of words in the listing request including the suggested title; and
add a word from the plurality of words to the refined title based at least in part on the machine learning model.

19. The non-transitory computer-readable medium of claim 15, wherein the instructions to generate the refined tide are executable to:
identify a plurality of words in the listing request including the suggested title; and
exclude, from the refined title, a word from the plurality of words based at least in part on the machine learning model.

20. The non-transitory computer-readable medium of claim 15, wherein the instructions to generate the refined title are executable to:
select a relative order between two or more words in the refined title based at least in part on the machine learning model.
